(19) United States
(12) Patent Application Publication
(10) Pub. No.: US 2024/0151660 A1
(43) Pub. Date: May 9, 2024

(54) SYSTEM FOR IMAGE ACQUISITION, ANALYSIS, AND CHARACTERIZATION OF TISSUE SAMPLES

(71) Applicant: Diagnostic Instruments, Inc., Sterling Heights, MI (US)

(72) Inventor: Philip T. Merlo, Clarkston, MI (US)

(21) Appl. No.: 18/501,638

(22) Filed: Nov. 3, 2023

Related U.S. Application Data
(60) Provisional application No. 63/422,662, filed on Nov. 4, 2022.

(51) Int. Cl. G01N 23/046

(52) U.S. Cl. CPC G01N 23/046; G01N 2223/1016; G01N 2223/32; G01N 2223/321; G01N 2223/401; G01N 2223/427; G01N 2223/6126

(57) ABSTRACT

An apparatus for imaging and analyzing a tissue sample includes a rotating table with integrated weighing apparatus for supporting and rotating a platform supporting a tissue sample. A laser line generator projects a laser line onto the platform and the tissue sample. A profiling camera captures images of the laser line upon the tissue sample as the platform and tissue sample are rotated. An image analyzer/processor determines a plurality of laser lines profiles from the captured images of the laser line. The image analyzer/processor determines a tissue profile of the tissue sample from the plurality of laser line profiles.

### CROSS REFERENCE TO RELATED APPLICATION

The present application claims priority of U.S. provisional application Ser. No. 63/422,662 filed Nov. 4, 2022, which is hereby incorporated herein by reference in its entirety.

### FIELD OF THE INVENTION

The present invention is directed to the capturing of tissue sample images, and in particular, the analyzing and characterizing of captured tissue sample images.

### BACKGROUND OF THE INVENTION

Conventional tissue samples, such as those processed and studied in a biobank or pathology department, or other similar facility, are often embedded into paraffin wax blocks for later sectioning or slicing. The paraffin embedded tissue blocks are sliced (sectioned) with each slice of the tissue placed onto respective slides. Each sample slice is processed, and the final stained tissue sample slice covered and then stored. Each of the stored tissue slides may also be individually identified for later retrieval.

### SUMMARY OF THE INVENTION

Embodiments of the present invention provide an apparatus and methods for imaging tissue samples, analyzing the captured images, and characterizing features in the tissue samples. Such analysis also includes identifying and accounting for fiduciary markers within multiple images such that a tissue sample on a fiduciary platform may be imaged and then moved to another location for further imaging.

An embodiment of the present invention includes an apparatus for imaging and analyzing a tissue sample includes a rotating table with integrated weighing apparatus for supporting and rotating a platform supporting a tissue sample. A laser line generator projects a laser line onto the platform and the tissue sample. A profiling camera captures an image of the laser line upon the tissue sample. An image analyzer/processor determines a plurality of laser line profiles from the captured laser line images as the platform and tissue sample are rotated. The image analyzer/processor determines a tissue profile of the tissue sample from the plurality of laser line profiles.

In another embodiment of the present invention, an apparatus for imaging and analyzing a tissue sample includes a platform configured to support a tissue sample. The platform comprises a plurality of fiduciary markers. The apparatus further includes a first imaging apparatus configured to capture a first image of the tissue sample and the fiduciary markers on the platform, and a second imaging apparatus configured to capture a second image of the tissue sample and the fiduciary markers on the platform. The second imaging apparatus is a different imaging modality compared to the first imaging apparatus. The apparatus also includes an image analyzer/processor configured to convert the first image into an overlay image. The image analyzer/processor is configured to adjust the distances between the fiduciary markers in the second image with respect to the overlay image and to adjust an angle between the fiduciary markers and their respective platforms to achieve a same orientation between the first image and the second image.

In an aspect of the present invention, an apparatus is provided for machine-readable optical code tracking, imaging, and analyzing images of tissue samples.

In another aspect of the present invention, the rotating table comprises a mounting hub comprising a centration pin and an orientation and rotary drive pin. The platform comprises a centration registration hole configured to receive the centration pin, such that the platform is centered upon the rotating table. The platform further comprises a rotary drive hole configured to receive the orientation and rotary drive pin, such that the platform is properly orientated upon the rotating table. The rotary drive pin is configured to rotate the platform when inserted into the rotary drive hole of the platform.

In yet another aspect of the present invention, the apparatus includes an imaging camera and a light source. The imaging camera is configured to capture images of the tissue sample on the platform. The tissue samples in the captured images are evenly illuminated by the light source.

In a further aspect of the present invention, the image analyzer/processor is configured to generate written descriptions of the tissue sample.

In yet another aspect of the present invention, the written descriptions comprise one or more of quantity, size, weight, tissue color, texture, and other anatomical feature descriptions used in diagnostic reporting.

In a further aspect of the present invention, the image analyzer/processor is configured to send the written descriptions to an electronic medical records system.

In yet another aspect of the present invention, the first imaging apparatus is an X-ray imager, while the second imaging apparatus is a visible light imager.

In another aspect of the present invention, the first imaging apparatus is in a different location from the second imaging apparatus, such that the platform has been transferred from the location of the first imaging apparatus to the location of the second imaging apparatus.

In a further aspect of the present invention, the image analyzer/processor is configured to annotate the locations of biologically occurring features in the tissue sample. The image analyzer/processor is configured to produce an annotation overlay that comprises the annotations. The annotations represent guidelines for dissection.

In another aspect of the present invention, the apparatus further includes an annotations projector configured to project the annotations onto the tissue sample. The apparatus further yet includes a robotic tissue handling system configured to cut and pick the tissue sample as guided by the annotations projected onto the tissue sample.

In yet another aspect of the present invention, the apparatus includes a telecommunication connection between a remote consultor and the apparatus and allows annotations produced by the remote consultor to be projected on to the tissue for either manual or robotic interaction with the tissue.

Thus, tissue samples on a platform may be weighed, their individual weights/volumes with respect to the other tissue samples on the platform determined, and with the use of a laser line generator and profiling camera, a three-dimensional tissue profile can be determined for each tissue sample on the platform. With the use of a light source and imaging camera, the tissue samples are imaged, and their captured images analyzed by an image analyzer/processor. By analyzing the captured images, the image analyzer/processor is configured to generate a standardized written description (using conventional anatomical terms) of the tissue samples on the platform. Such anatomical feature descriptions used in diagnostic reporting can include, for example, quantity of samples, size of individual samples, total sample weight, identified tissue color(s), identified tissue texture(s), and the like. The written descriptions are then provided by the image analyzer/processor to an electronic medical records system (such as in a hospital system). Other platforms may also be used that include fiduciary markers (e.g., pins and other features) in set locations. These fiduciaries allow a tissue sample imaged by a first image modality (i.e., imaging technology) to be transferred to a second imaging modality. The live image from the first modality is overlayed onto the live image of the second modality and when the fiduciary angles and distances are adjusted, the tissue sample(s) will be in the same orientation for the second modality as in the first modality.

These and other objects, advantages, purposes, and features of the present invention will become apparent upon review of the following specification in conjunction with the drawings.

### BRIEF DESCRIPTION OF THE DRAWINGS

FIG. 1 is a block diagram of an exemplary imagery processing and analysis system in accordance with an embodiment of the present invention;

FIG. 2A is a side view of an exemplary circular platform positioned upon a weight scale in accordance with an embodiment of the present invention;

FIG. 2B is a front view of the circular platform of FIG. 2A;

FIG. 3A is another side view of the circular platform of FIG. 2A positioned upon an integrated weight scale and encoded rotary motor in accordance with an embodiment of the present invention;

FIG. 3B is yet another side view of the circular platform of FIG. 2A positioned upon an alternative integrated weight scale and encoded rotary motor with an exemplary platform in accordance with an embodiment of the present invention;

FIG. 4 is a side view of the circular platform and integrated weight scale, encoded rotary motor, and platform with an arrangement of exemplary cameras, a laser line generator, and a light source in accordance with an embodiment of the present invention;

FIG. 5A is a side view illustrating the placement of the cameras and laser line generator of FIG. 4 with respect to a tissue sample on a circular platform in accordance with an embodiment of the present invention;

FIG. 5B is a top-down view of the cameras and laser line generator of FIG. 5A with respect to the circular platform with tissue sample of FIG. 5A;

FIG. 5C is another side view of the cameras and laser line generator of FIG. 5A with respect to the circular platform of FIG. 5A;

FIG. 6A is a diagram illustrating a laser line measurement with respect to image pixels in accordance with an embodiment of the present invention;

FIG. 6B is a perspective view a tissue sample with exemplary laser line profiles for determining the tissue sample's tissue profile in accordance with an embodiment of the present invention;

FIG. 7 is flowchart of the steps to a method for weighing tissue samples and calculating individual weights as a percentage of volume in accordance with an embodiment of the present invention;

FIG. 8 is an exemplary live image of a tissue sample on a platform with fiduciary markers in accordance with an embodiment of the present invention;

FIG. 9 is an overlay image based upon the live image of FIG. 8 in accordance with the embodiment of the present invention;

FIG. 10 is the overlay image of FIG. 9 illustrating the calculation of overlay fiduciary distance and overlay fiduciary angle in accordance with the embodiment of the present invention;

FIG. 11 is another live image of the platform with fiduciary markers of FIG. 8 and a live fiduciary distance and live fiduciary angle are calculated from the live image in accordance with the embodiment of the present invention;

FIG. 12 illustrates the relationships between an annotation layer, the resized and aligned overlay image of FIG. 10, and the live image of FIG. 11 in accordance with the embodiment of the present invention; and

FIG. 13 is a perspective view of a tissue sample on a platform with fiduciary markers, and the placement of an imaging camera and an annotations projector projecting annotations on the tissue sample, as well as illustrating the placement of a robotic tissue handling system with respect to the tissue sample and the platform, such that robotic tissue handling system can handle the tissue sample and platform and perform any needed cuts or sections in the tissue sample as guided by projected annotations on the tissue sample in accordance with the embodiment of the present invention.

### DESCRIPTION OF THE PREFERRED EMBODIMENTS

Referring to the drawings and the illustrative embodiments depicted therein, tissue samples (e.g., biopsy specimens) on a platform may be weighed, their individual weights/volumes with respect to other tissue samples on the platform determined, and a tissue profile (three-dimensional shape) determined for each tissue sample on the platform. A laser line generator and profiling camera may be used to determine the tissue profile. A light source and imaging camera may be used to image the tissue samples and the captured images analyzed by an image analyzer/processor. The image analyzer/processor analyzes the captured images to automatically generate a written description of the tissue samples on the platform based upon the identified anatomical features. For example, quantity, size, weight, tissue color, texture, and other anatomical feature descriptions used in diagnostic reporting can be generated. These written descriptions are provided to an electronic medical records system (such as in a hospital). Other platforms may also be used that include fiduciary markers (e.g., pins) in set locations. These fiduciary markers allow a tissue sample imaged by a first image modality (or type of imaging technology, e.g., X-ray imaging or visible light imaging) to be transferred to a second imaging modality. A live image from the first modality can be overlayed onto a live image of the second modality and when fiduciary angles and distances are adjusted, the tissue sample(s) will be in the same orientation for the second modality as in the first modality.

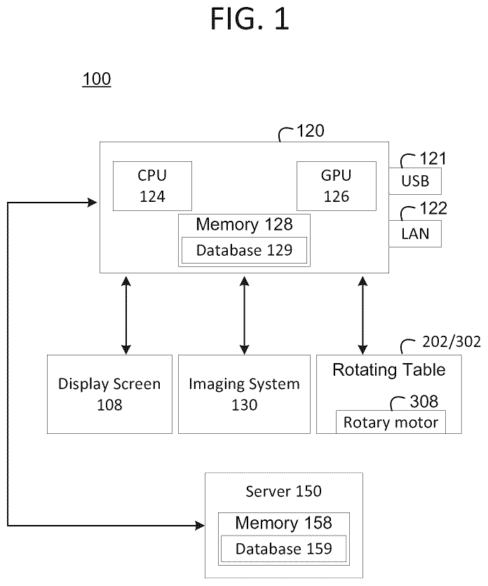

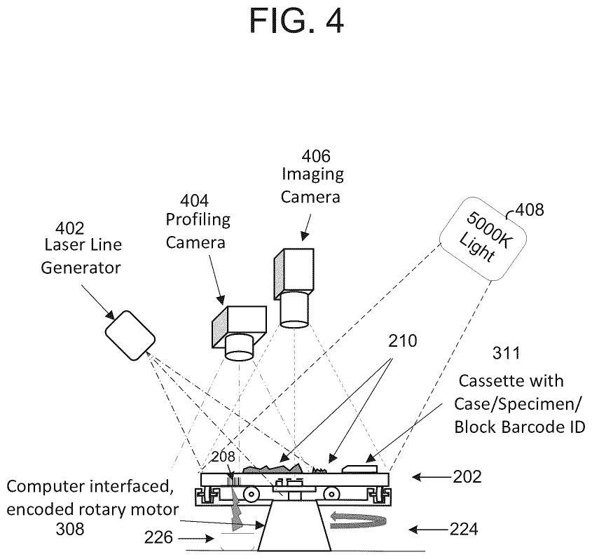

FIG. 1 illustrates an exemplary imagery processing & analysis system 100, which includes an image analyzer and processor (“image analyzer/processor”) 120 and an imaging system 130. As illustrated in FIG. 1, the image analyzer and processor (image analyzer/processor) 120 includes an image acquisition and archiving module and an image analysis module, both of which may be implemented as separate hardware modules of a multi-core graphics processing unit (GPU) 126 or as software modules implemented by a multi-core micro processing unit (CPU) 124. The imagery processing & analysis system 100 includes a memory 128 for storing data to a database 129. FIG. 1 also illustrates the imagery processing & analysis system 100 communicatively coupled to a server 150 that provides the storage and retrieval of archived imagery and current data, such as to a database 159 stored in a memory 158. The imaging system 130 may be implemented as either stand-alone instruments, such as illustrated herein (see FIGS. 4, 5, and 14) or the imaging system 130 may be incorporated as an accessory of a tissue slicing instrument (e.g., a microtome or other similar instruments), or as a fiduciary platform with integrated scale and imaging system. The imaging system 130 captures images of tissue samples 210, 311 such as paraffin wax embedded tissue samples or slides carrying tissue sample slices.

Optionally, and as illustrated in FIG. 1, the imagery processing & analysis system 100 includes external USB ports 121 arranged on a housing to facilitate accessory connections (e.g., mouse, keyboard, optical code (e.g., barcode and QR code) scanner, and thumb drive access). An external LAN port 122 may also be provided to allow for connection to an institution's network. An external power switch may be arranged for powering ON/OFF a lighting system (e.g., lighting system of FIG. 4). Similarly, a main power switch for the image analyzer/processor 120 and imaging system 150 may also be arranged on the housing of the imagery processing & analysis system 100.

The image acquisition and archiving module of the image analyzer/processor 120 provides a user interface (displayed on a display screen 108 of the imagery processing & analysis system 100) for control of the imaging system 130. The image acquisition and archiving module may also provide a user with access to a hospital or similar institute's information technology (IT) infrastructure and electronic archives. The image acquisition and archiving module may also read an identifier machine-readable optical code on images of paraffin block cassettes and tissue sample slides to allow for the automatic archiving of the associated images. Additionally, the image analysis module will archive the imagery analysis results into the specific patient/case electronic files stored in the LIS.

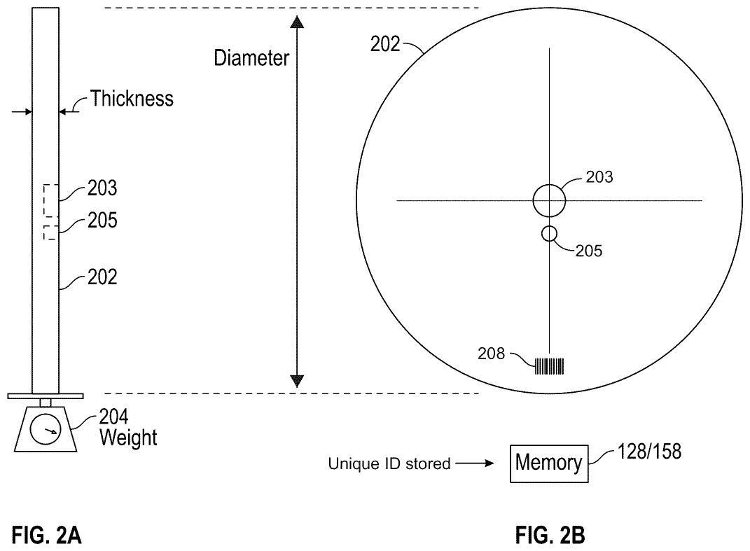

With reference to FIGS. 2A and 2B, an exemplary circular platform 202 is for weighing, transporting, and imaging of specimen biopsies. The circular platform 202 has an accurate and consistent thickness (to the extent necessary) through its angular rotation and thus providing a standardized biopsy platform. Furthermore, an exemplary circular platform 202 has an appropriate color to provide adequate contrast with the specimens to produce good images (examples include light blue or white). Lastly, the circular platform 202 is manufactured from a material that is easily washed and disinfected (e.g., polyethylene).

As illustrated in FIG. 2A, each circular platform 202 is placed upon a scale 204 for determining a weight, which is tracked by an identification (ID) system, such as a unique ID 208 (identification markings or technologies, e.g., machine-readable optical codes, RFIDs, and the like) for each circular platform 202. The weight, thickness, and corresponding unique ID 208 (e.g., optical code) for the circular platform 202 are stored together in a corresponding computer file/application setting (e.g., the databases 129, 159 of memories 128, 158). These are used as offsets in calculation of weight and sample thickness to account for any variances in platform manufacturing.

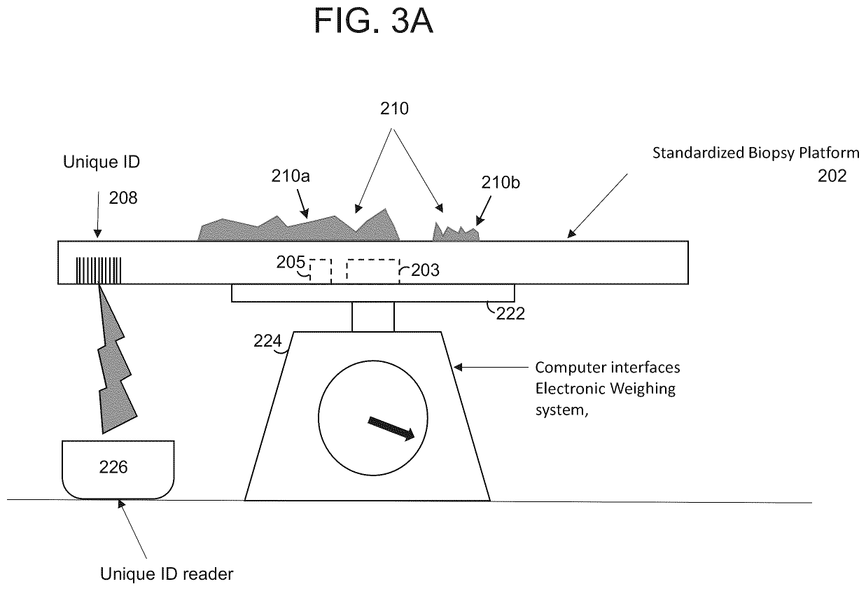

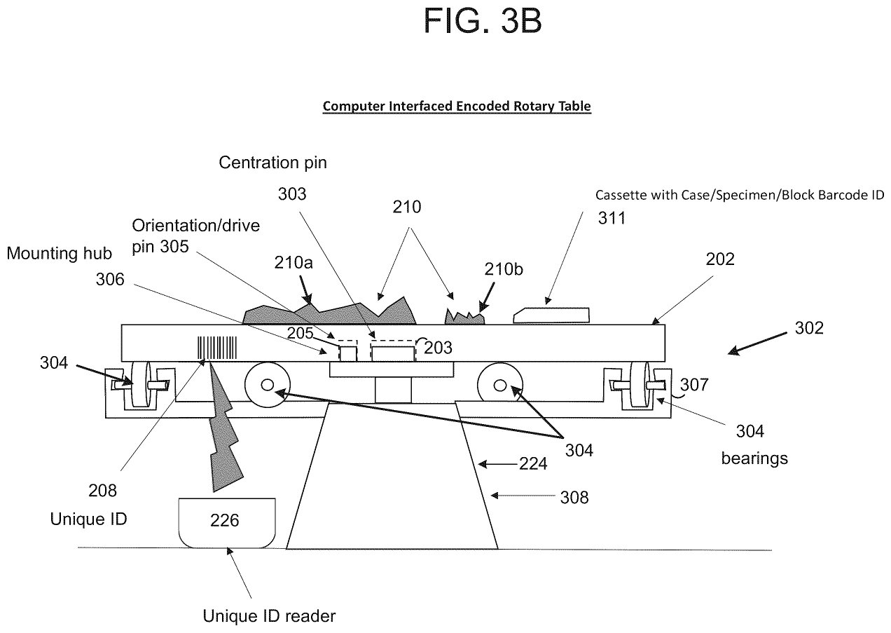

As illustrated in FIGS. 2A and 2B, each circular platform 202 includes a centration registration hole 203 and an orientation and rotary drive hole 205. The centration registration hole 203 and orientation and rotary drive hole 205 are configured to mate with a corresponding centration pin 303 and an orientation and rotary drive pin 305, respectively, of an exemplary biopsy platform mounting hub 306 (FIG. 3B). Alternatively, the circular platform 202 can mate in a similar fashion with a rotating table 222 with an integrated digital scale 224 (FIG. 3A). Note that the circular platform 202 has a known diameter. As illustrated in FIG. 3A, a circular platform 202 with a known weight and thickness (and associated unique ID 208) is placed upon the rotating table 222 (which is coupled to the digital scale 224). Note that the unique ID 208 can be any form of unique identification, e.g., machine-readable optical code, RFID, and the like.

Referring to FIGS. 3A and 3B, biopsy pieces 210 are placed upon the circular platform 202. A first biopsy piece 210a and a second biopsy piece 210b are placed on the circular platform 202 (FIG. 3A). FIG. 3B illustrates the biopsy pieces 210a and 210b, along with an exemplary cassette 311 with case, specimen, or block, and associated unique ID 208 (e.g., a machine-readable optical code or RFID). As illustrated in FIGS. 2-4, a unique ID reader 226 (e.g., an optical code reader, RFID reader, and the like) is positioned to capture/read the unique ID 208 on the circular platform 202. By reading the platform's unique ID 208 (e.g., a machine-readable optical code), the imagery processing & analysis system 100 is configured to capture the case numbers and/or cassette block numbers the tissue blocks or tissue samples upon the circular platform 202 are assigned to.

FIG. 3B is a cross-sectional view of a circular platform 202 placed upon an alternative rotating table 302 with an integrated digital scale 204 and exemplary computer interfaced, encoded rotary motor 308. The internal components of the rotating table 302 are illustrated. The rotating table 302 includes a platform support 307 with roller bearings 304. The rotating table 302 also includes a mounting hub 306, which includes a centration pin 303 and an orientation and rotary drive pin 305. As illustrated in FIG. 3, the centration pin 303 inserts into the centration registration hole 203 (which is illustrated in outline), while the orientation and rotary drive pin 305 inserts into the orientation and rotary drive hole 205 (which is also illustrated in outline). The encoded rotary motor 308 rotates the mounting hub 306, thereby rotating the orientation and rotary drive pin 305 to rotate the circular platform 202 resting upon the rotating table 302. The encoded rotary motor 308 is communicatively coupled to an image analyzer/processor 120 for monitoring and calculating weights, storing optical code associated data (in at least one of the databases 129, 159 of the memories 128, 158), and controlling the operation of the encoded rotary motor 308 (see FIG. 1).

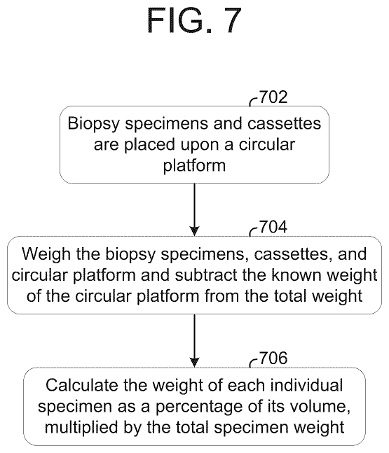

With reference to FIGS. 3A and 3B, the digital scale 204 is used to weigh the tissue samples 210 and/or cassettes 311 (with case, specimen, or block). The tissue samples 210 and cassettes 311 are placed upon a circular platform 202 for weighing. As illustrated in FIG. 7, in a method for determining the weights of tissue samples and/or cassettes 311, in step 702, the tissue samples 210 and cassettes 311 are placed upon a circular platform 202 (that is resting upon a rotating table 202, 302). In step 704, the tissue samples 210, cassettes 311 and circular platform 202 are weighed and the known weight of the circular platform 202 is removed from the total weight to determine a total specimen weight. In step 706, the weight of each individual specimen (e.g., tissue samples 210a, 210b, and cassette 311) is calculated as a percentage of its volume, as discussed herein (see FIG. 3), to the total volume of all specimen pieces, multiplied by the total specimen weight calculated in step 704.

As illustrated in FIG. 4, an exemplary laser line generator 402 is positioned with respect to the circular platform 202, which is positioned upon the rotating table 302. A profiling camera 404 and an imaging camera 406 are also positioned with respect to the circular platform 202. As the specimen pieces 210, 311 are rotated upon the circular platform 202 (by the encoded rotary motor 308), the specimen pieces 210, 311 are imaged by the profiling camera 404 and the imaging camera 406 and scanned by the laser line generator 402 (which is viewed by the profiling camera 404). The laser line generator 402 is positioned to scan across the circular platform 202, running through the center of the circular platform 202 and at a 45° angle at the 0° rotational position of the rotational platform 202 (see FIG. 4). The profiling camera 404 is positioned at a 45° angle at the 270° rotational position of the rotational platform 202 to view the laser line generator 402.

The profiling camera 404 is configured with a narrow band filter to reduce the capture of non-laser light (from the laser line generator 402) in its images. The pass band of the filter will correspond to the wavelength of the laser line generator 402. Note that the encoded rotational motor 308, under the control of the image analyzer/processor 120, will rotate the circular platform 202 a calibrated number of degrees with each rotational movement. The image analyzer/processor 120 directs the encoded rotational motor 308 to rotate the circular platform 202 a set number of degrees and then the profiling camera 404 will capture an image. This process will be completed until the circular platform 202 is rotated through a full 360° rotation.

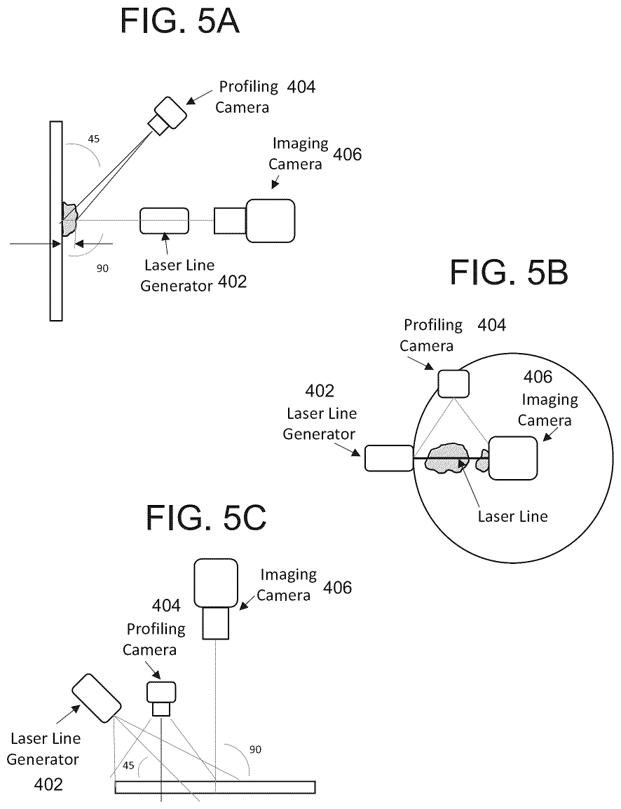

The profiling camera 404 will be calibrated to the height of the circular platform 202 (sitting atop the rotating table 202, 302) and with standardized reference targets (e.g., gauge blocks) to provide a known length, width, and thickness measurements for individual specimens 210, 311 placed upon the circular platform 202 and the stored thickness offset stored and corresponding to the stored platform optical code being used. Specimen measurements will be calculated from measurements made on a compiled images set (from the profiling camera 404), the known geometry, the known rotation of the circular platform 202, the platform thickness offset, and the calibration settings. A tissue profile (a three-dimensional shape) will be calculated from the series of successive images using the geometry of the profiling camera 404 and the rotation of the circular platform 202. FIGS. 5A, 5B, and 5C further illustrate the positioning of the laser line generator 402, the profiling camera 404, and the imaging camera 406 with respect to tissue samples 210, 311 on the circular platform 202. For example, FIGS. 5A and 5C are side views with respect to the circular platform 202 and illustrating the positioning and orientation of the laser line generator 402, the profiling camera 404, and the imaging camera 406 with respect to each other. FIG. 5B is a top-down view with respect to the circular platform 202 and illustrating the placement or orientation of the laser line generator 402, the profiling camera 404, and the imaging camera 406. Note that FIGS. 5A and 5B also illustrate the location of the samples 210, 311 with respect to the laser line generator 402, the profiling camera 404, and the imaging camera 406.

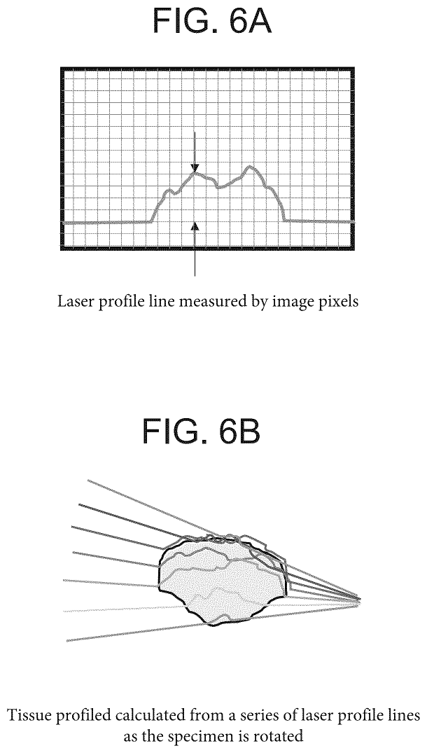

As illustrated in FIGS. 6A and 6B, the image analyzer/processor 120 is configured to calculate a sample thickness from a pixel offset of a laser line profile imaged by the profiling camera 404 from a baseline of the laser line profile on the circular platform 202. The pixel offset is calibrated using the above-described reference standards, e.g., gauge blocks. Thus, an exemplary tissue profile (comprising a plurality of laser line profiles or cross-sections) will be calculated from the series of images taken across successive images using the geometry of the profiling camera 404 to the circular platform 202 and the rotation of the circular platform 202. As illustrated in FIG. 6A, each laser line profile is measured by image pixels as a pixel offset from the expected location of the laser line profile (the circular platform 202). Thus, each laser line profile or cross-section illustrated in FIG. 6B corresponds to a resultant pixel offset as illustrated in the cross-sectional area of each laser line profile (FIG. 6A).

From the compiled images set, the information about the specimens will be computed (by the image analyzer/processor 120). Such computations can include the cassette optical code or RFID, number of specimens, the length, width, thickness, and volume of each individual specimen, and the surface texture descriptions of the specimens. As illustrated in FIG. 6B, by rotating the sample on the circular platform 202, a rotational series of laser line profiles (each with their own pixel offsets) can be determined. FIG. 6B illustrates pluralities of laser line profiles originating from a common point and falling out across the specimen, each with their own profile across the specimen. The plurality of laser line profiles also allow for the detection of boundary edges of the specimen. When combined, the rotational series of laser line profiles provides a three-dimensional tissue profile representation (see FIG. 6B). As discussed herein, from the laser line profiles, in addition to thickness, specimen length and width (based on specimen edges) can also be calculated.

As illustrated in FIG. 4, an imaging camera 406 is positioned centered above the circular platform 102. The imaging camera 406 is a color imager. A 5000K full spectrum light is obliquely positioned to illuminate the specimen pieces 210, 311 evenly and consistently. An exemplary 5000K light 408 is illustrated in FIG. 4. By placing the 5000K light 408 obliquely, the 5000k light 408 is positioned at an angle to the axis of the cameras 406. The image analyzer/processor 120 controls the imaging camera 406 and actively adjusts its image acquisition settings and automatically acquires images into a case archive location (e.g., databases 129, 159 of memories 128, 159) as well as to store data into a temporary computation buffer (e.g., a location within memory 128).

In an aspect of the present embodiment, the image analyzer/processor 120 provides written descriptions for each of the specimens 210, 311 on the circular platform 102. Such descriptions for a sample (tissue samples on a platform) can include one or more of: quantity of pieces, sample size, weight, the tissue color, tissue texture, and other anatomical feature descriptions used in diagnostic reporting. Such descriptions would be based on the image analyzer/processor 120 performing image processing and analysis of the images captured and upon three-dimensional representations of the sample obtained. Such computational steps performed by the image analyzer/processor 120 can be performed via artificial intelligence algorithmic processes. That is, image processing is used to identify certain descriptive qualities of a sample (size with respect to reference objects, color, identified textures, and the like).

Such computational steps can also include comparing the number of pieces reportedly delivered (and on a platform 202) as compared to the number of pieces actually counted in the previous steps (from the analyzed images). If there is a difference, the image analyzer/processor's algorithm(s) can provide notification to an operator to take a prescribed action as indicated by an associated laboratory's standard operating procedures.

The computational algorithms performed by the image analyzer/processor 120 also include an exemplary algorithm for the automated reading of case and specimen optical codes from the captured images (via image processing and analysis). The algorithm is further capable of communicating with an electronic medical records system (e.g., via the image analyzer/processor 120 and the server 150) and providing for the automatic filing to the electronic records system of the following exemplary items: the captured images, the number of sample pieces, sample sizes, sample weights, diagnostic descriptions, and a formatted sample thickness tracking file.

An exemplary formatted sample thickness tracking file is encoded with the sample block UID, a case #, and block ID (depending on the type of sample(s) processed). The formatted sample thickness tracking file can be used to record the original sample or multiple samples' thicknesses within the paraffin block within which they reside. The thickness of sample cuts made to the block are recorded. The formatted sample thickness tracking file is also used to provide metrics related to the sample thickness, such as, the estimated remaining tissue in the block, and the estimated percentage of depth cut any slide is from. Thus, an estimated percentage of depth cut and an estimated remaining tissue remaining in block can be calculated. This file will also contain the fixation time recorded for this sample. The file will be available to the various instruments used to process the sample for recording actions made on the sample. The file data would also be part of the digital file maintained within the case documentation in the electronic medical records.

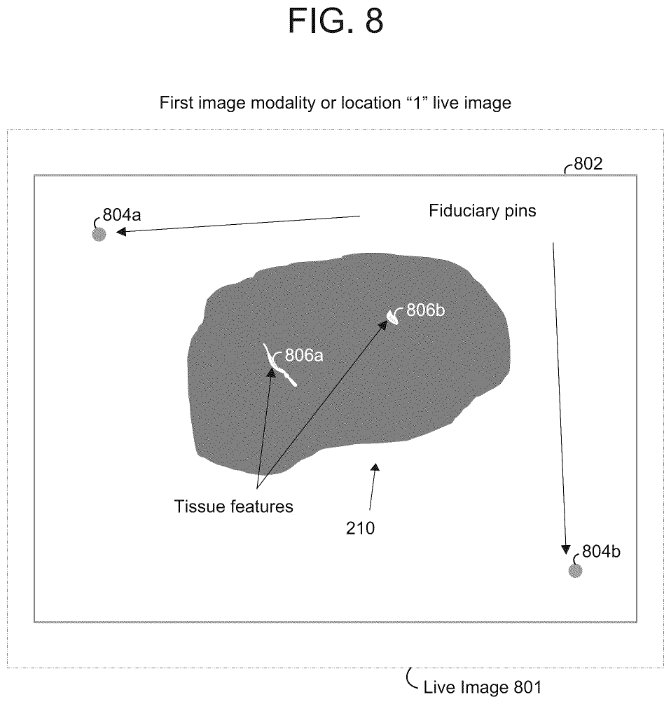

With respect to FIG. 8, a specimen 210 is positioned for processing on a platform 802 (e.g., on a circular platform 202 or other similar platform). The platform 802 is configured to support at least one specimen 210 and includes two or more fiduciary markers 804a, 804b. The fiduciary markers 804a, 804b will be manufactured with a uniquely identifiable color or other distinguishing characteristic, such as, shape or other property that can be identified in each image modality or technology (e.g., X-ray imaging, visible light imaging, etc.).

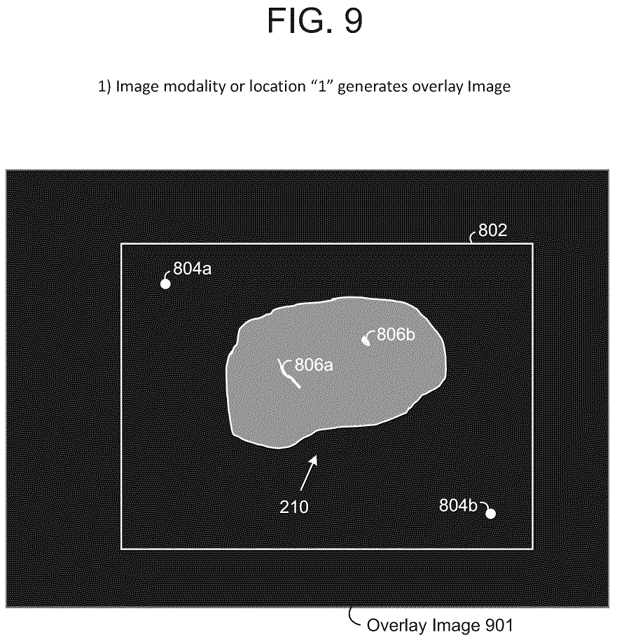

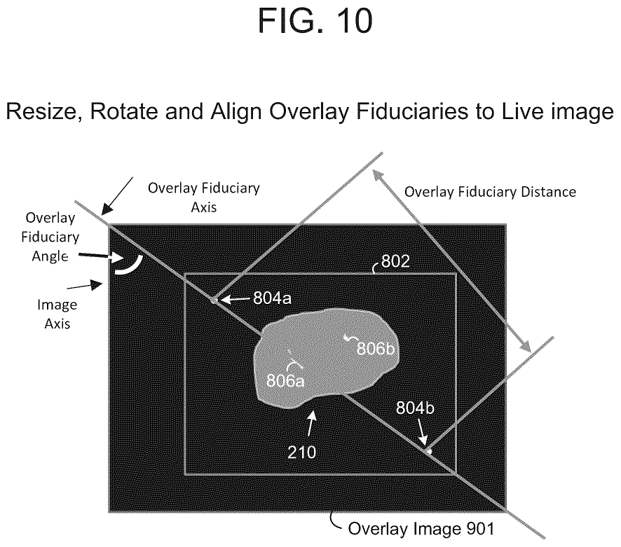

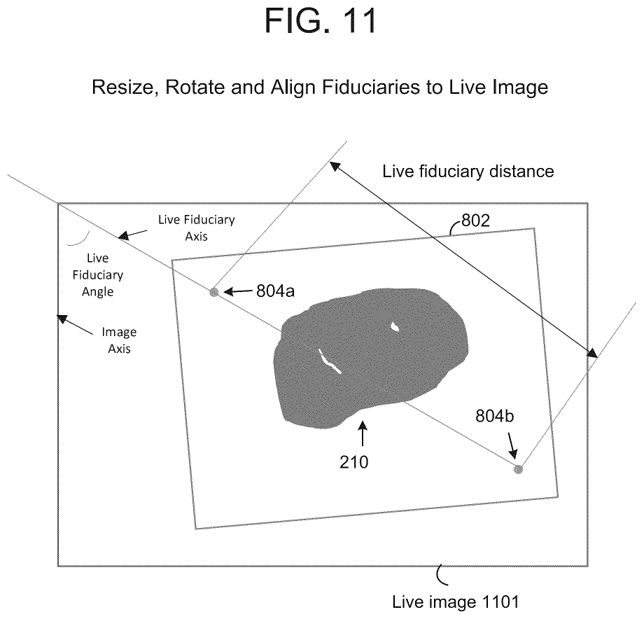

FIG. 8 illustrates a live image 801 of a tissue sample 210 positioned upon a platform 802 that includes a pair of fiduciary markers 804a, 804b. Such live images of a specimen on a platform with fiduciary markers can be used as image overlays from one image modality to another (e.g., X-ray to visible light grossing) or from a first (“1”) location to a second (“2”) location (e.g., moving from a remote surgical suite to a frozen section lab). FIG. 9 illustrates an exemplary image overlay 901 of the live image 801 of FIG. 8. As described herein, the corresponding fiduciary markers 804a, 804b from the live image 801 will be identified in both the overlay image 901 and in a second image modality, and used to orient and resize the overlay image 901 to match the fiduciaries 804a, 804b in the second image modality (see FIGS. 10 and 11). That is, the overlay image 901 will be adjusted such that the image of the fiduciary markers 804a, 804b (of the platform 802) in the overlay image 901 will be oriented and adjusted to match the positions of those same fiduciaries 804a, 804b (of the platform 802) now seen in the second image modality.

The platform 802 (with the tissue samples 210 placed upon it) can then be transferred from one image modality system (e.g., X-ray system) to another image modality system (e.g., visible light) without removing the tissue sample 210 from the platform 802 (the tissue samples 210 remain on the platform 802 throughout and remain in the same orientation with respect to the fiduciaries 804a, 804b). This allows the image from the first modality to be overlayed onto the live image of the second image modality (e.g., from an X-ray machine (1^{st} modality) to a dissection bench (2n d modality) that includes an imaging camera).

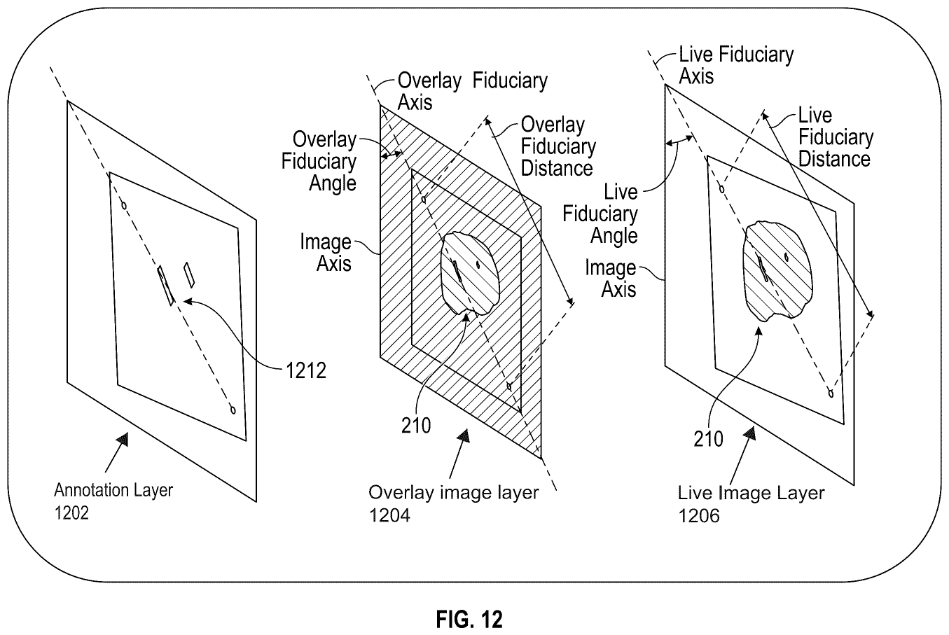

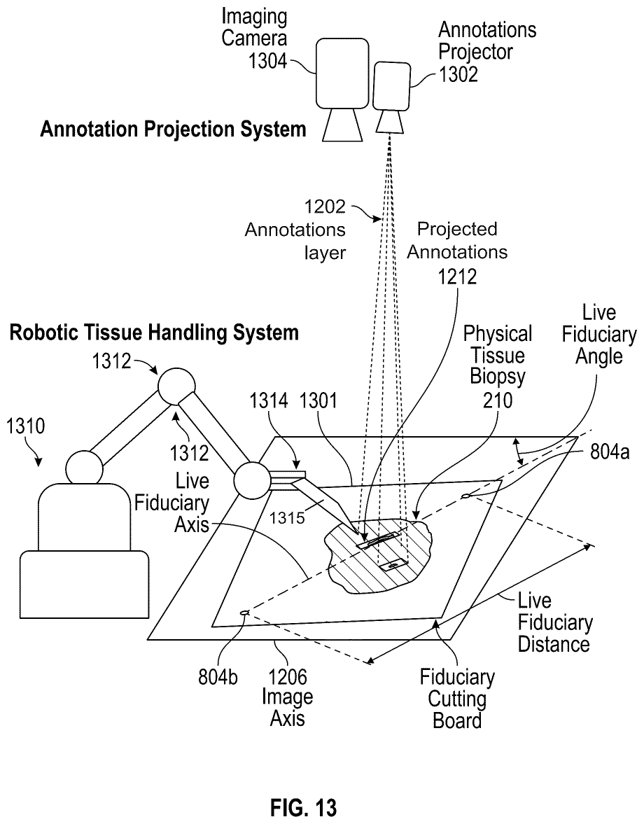

In an alternative embodiment, the tissue sample 210 can be removed from the platform 802 and placed onto another platform but with the same fiduciary placement. An image from the first platform is overlayed (e.g., image overlay 901) onto a new live image of the different platform with the same fiduciary placement, such that the fiduciary marker placement in the image overlay 901 matches the fiduciary placement in the new live image. The tissue sample 210 is then arranged on the different platform (with matching fiduciaries 804a, 804b) to match the overlay image 901. For example, if there is a remote physician/surgeon using a cutting board/platform system with standardized fiduciary marker locations, the physician/surgeon can image a tissue sample prior to it leaving the procedure suite. The physician/surgeon can also mark up the image with the locations of dissection cuts and tissue block sampling and thereby create an annotation overlay 1202 along with an image overlay 901, 1204 (see FIGS. 8, 9, 12, and 13). Then, upon receipt of the tissue sample 210 at a grossing lab, the tissue sample 210 can be placed onto a matching fiduciary cutting board (with the same fiduciary placement) using the image overlay 901 as a guide to match the original position of the tissue sample 210 with respect to the fiduciaries 804a, 804b in the image overlay 901 to the fiduciaries 804a, 804b on the matching fiduciary cutting board (with the fiduciary positions in the image overlay 901 matching the fiduciary positions in the matching cutting board/platform, the tissue sample 210 can be positioned with respect to its original position). The original image (e.g., both the image overlay 901, 1204) from the physician/surgeon will be oriented and sized to fit the tissue sample 210 relocated to the matching cutting board/platform (and its fiduciaries 804a, 804b), allowing a technician in the grossing lab to observe the location of the physician/surgeon's dissection request markings via the annotation overlay 1202 (see FIGS. 12 and 13). That is, the annotation overlay 1202 is also oriented and sized according to the matching fiduciary positions.

The imaging software (e.g., the image analysis algorithms executed in the image analyzer/processor 120) will then have the capability that allows the operator/technician to draw annotations 1212 around objects or biologically occurring features (e.g., locations of calcification to be dissected out) in the tissue sample (FIG. 13). These annotations 1212 will represent guidelines for dissection (e.g., the annotation layer 1202 in FIGS. 12 and 13).

In another alternative embodiment, a remote physician/surgeon would be able to virtually view the tissue sample 210 using teleconferencing software, capture an image of the tissue sample 210 and markup this captured image (e.g., with annotations 1212). The markups 1212 indicate the dissection and sample block locations on the image (e.g., the annotations 1212 of an annotation layer 1202, such as in FIGS. 12 and 13). This annotation image 1202 (with annotations 1212) in turn would be overlayed onto the live sample image providing the annotated dissection guidelines. Thus, the use of image layers allow for a physician/surgeon, whether via an on-site computer system or a remote virtual remote connected computer system, to capture images of a tissue sample, mark up the captured image to indicate the dissection and sample block locations on the image (for eventual overlay onto a live sample image to provide annotated dissection guidelines at a later time and/or location).

In a further alternative embodiment, a computation software program (e.g., the image analyzer/processor 120), once trained, can identify the locations of objects and biologically occurring features in a tissue sample (e.g., locations of calcification to be dissected out). The computation software will then plot dissection cutting lines (e.g., annotations 1212 for an annotation layer 1202) that will guide the excision of this tissue sample. Thus, the computational software is configured to automatically lay out onto the image of the tissue sample captured, the section cutting lines and tissue block cutting lines (via annotations 1212) for tissue sample excision.

Thus, with respect to FIGS. 12 and 13, an annotation layer 1202 (with annotations 1212) and a resized and aligned overlay image layer 1204 are both overlayed over a current live image 1206 of a tissue sample 210. With reference to FIGS. 10 and 11, an exemplary resizing of the overlay image layer 901 includes increasing or decreasing the image size of the overlay image layer 901 based upon a distance between the fiduciaries 804a, 804b in the overlay image 901 versus the distance between the fiduciaries 804a, 804b in the live image 1101 (see FIG. 11). In an aspect of the present embodiment, an exemplary overlay scale resize factor can be defined as:

$$overlay scale resize factor = \frac{live fiduciary distance}{overlay fiduciary distance} . \qquad ( 1 )$$

Similarly, an exemplary rotation alignment of the overlay image layer 901 includes rotating the overlay image 901 based upon a fiduciary angle in the overlay image 901 versus the fiduciary angle in the live image 1101. With respect to FIG. 10, the overlay fiduciary angle is the axis of the fiduciaries 804a, 804b in the overlay image 901 with respect to the axis of the overlay image 901. Similarly, with respect to FIG. 11, the live fiduciary angle is the axis of the fiduciaries 804a, 804b in the live image 1101 with respect to the axis of the live image 1101. In the same fashion, an exemplary overlay rotation alignment can be defined as:
(2) Overlay rotation alignment=live fiduciary angle−overlay fiduciary angle.

With respect to FIG. 13, an exemplary annotation projector 1302 and an imaging camera 1304 are positioned above a platform 1301 that is configured to function as a fiduciary cutting board. The annotation projector 1302 is configured to project an annotation layer 1202 onto the platform 1301 and tissue sample 210. The annotation projector 1302 projects previously determined cutting lines (annotations 1212) made by either the operator or the computation system (e.g., the image analysis algorithms executed in the image analyzer/processor 120) and projects them onto the tissue sample 210 to guide an operator's cutting of the tissue sample 210 for sample excision.

With respect to FIG. 13, an exemplary robotic tissue handling system 1310 is a computer controlled (e.g., via the image analyzer/processor 120) cutting system that will be guided by the cutting lines previously determined and discussed herein (e.g., annotations 1212 on an annotation layer 1202). The robotic tissue handling system 1310 provides for robotic or automated cutting, picking, cassette loading and storing. The robotic tissue handling system 1310 includes a robotic arm 1312 with an end apparatus 1314 for holding and using cutting tools 1315. The end apparatus 1314 is also configured for picking up and depositing the tissue samples 210 (e.g., tissue blocks) into appropriately identified (e.g., optical coded) processing cassettes as guided by an LIS interface, and labeling of the original sample container(s). The robotic tissue handling system 1310 is configured to handle the tissue sample 210 and platform 1301 and perform any needed cuts or sections in the tissue sample 210 as guided by projected annotations 1212 on the tissue sample 210. The robotic tissue handling system 1310 will be configured to deposit the filled cassettes into an appropriate processing basket based on tissue type and to record the time of deposit of the cassette as a start fixation time, and to transmit this information to the appropriate laboratory information system.

Thus, tissue samples (e.g., biopsy specimens) on a platform may be weighed, their individual weights/volumes with respect to the other tissue samples on the platform determined, and with the use of a laser line generator and profiling camera, a tissue profile can be determined for each tissue sample on the platform. With the use of a light source and imaging camera, the tissue samples are imaged, and their captured images analyzed by an image analyzer/processor. By analyzing the captured images, the image analyzer/processor is configured to provide a written description of the tissue samples on the platform, e.g., quantity of samples, size of samples, sample weight, tissue color, texture, and other anatomical feature descriptions used in diagnostic reporting. The written descriptions are then provided by the image analyzer/processor to an electronic medical records system. Other platforms may also be used that include fiduciary markers (e.g., pins) in set locations. These fiduciaries allow a tissue sample imaged by a first image modality to be transferred to a second imaging modality. The live image from the first modality is overlayed onto the live image of the second modality and when the fiduciary angles and distances are adjusted, the tissue sample(s) will be in the same orientation for the second modality as in the first modality.

Changes and modifications in the specifically described embodiments can be carried out without departing from the principles of the present invention which is intended to be limited only by the scope of the appended claims, as interpreted according to the principles of patent law including the doctrine of equivalents.

1. An apparatus for imaging and analyzing a tissue sample, the apparatus comprising:
a rotating table configured to support and rotate a platform supporting a tissue sample;
a laser line generator configured to project a laser line onto the platform and the tissue sample;
a profiling camera configured to capture images of the laser line upon the tissue sample as the platform and tissue sample are rotated; and
an image analyzer/processor configured to determine a plurality of laser line profiles from the captured images of the laser line, wherein the image analyzer/processor is configured to determine a three-dimensional tissue profile of the tissue sample from the plurality of laser line profiles.

2. The apparatus of claim 1, wherein the laser line is a laser line profile defining a cross-sectional profile of the tissue sample along the laser line, and wherein the laser line profile defines a thickness of the tissue sample.

3. The apparatus of claim 2, wherein the three-dimensional tissue profile is defined by a plurality of the laser line profiles across the tissue sample.

4. The apparatus of claim 1, wherein the rotating table comprises a weighing apparatus configured to weigh the tissue sample.

5. The apparatus of claim 1 further comprising an identification reader configured to read a unique identification on the platform, wherein the identification reader is an optical code reader or an RFID reader, such that the identification is a machine-readable optical code or a RFID device, respectively.

6. The apparatus of claim 1, further in combination with the platform, wherein the rotating table comprises a mounting hub comprising a centration pin and an orientation and rotary drive pin, wherein the platform comprises a centration registration hole configured to receive the centration pin, such that the platform is centered upon the rotating table, wherein the platform further comprises a rotary drive hole configured to receive the orientation and rotary drive pin, such that the platform is properly oriented upon the rotating table, and wherein the rotary drive pin is configured to rotate the platform when inserted into the rotary drive hole of the platform.

7. The apparatus of claim 1 further comprising an imaging camera and a light source, wherein the imaging camera is configured to capture images of the tissue sample on the platform, and wherein the light source is configured to evenly illuminate the tissue samples in the captured images.

8. The apparatus of claim 7, wherein the image analyzer/processor is configured to generate written descriptions of the tissue sample.

9. The apparatus of claim 8, wherein the written descriptions comprise diagnostic anatomical feature descriptions comprising one or more of quantity of samples in the tissue sample, dimensions of each sample of the tissue sample, weight of the tissue sample, tissue sample color, and tissue sample texture.

10. The apparatus of claim 9, wherein the image analyzer/processor is configured to send the written descriptions to an electronic medical records system.

11. The apparatus of claim 1, further in combination with the platform, wherein the platform comprises a plurality of fiduciary markers configured to define a placement of the tissue sample on the platform with respect to the fiduciary markers.

12. An apparatus for imaging and analyzing a tissue sample, the apparatus comprising:
a platform configured to support a tissue sample, wherein the platform comprises a plurality of fiduciary markers;
a first imaging apparatus configured to capture a first image of the tissue sample and the fiduciary markers on the platform, wherein the first imaging apparatus comprises a first imaging modality;
a second imaging apparatus configured to capture a second image of the tissue sample and the fiduciary markers on the platform, wherein the second imaging apparatus comprises a second imaging modality, wherein the second imaging modality is different from the first imaging modality; and
an image analyzer/processor configured to convert the first image into an overlay image, wherein the image analyzer/processor is configured to adjust a size and rotation of the second image with respect to the overlay image to achieve a same orientation and position of the tissue sample between the overlay image and the second image as defined by the positions of the fiduciary markers in the overlay image and the second image.

13. The apparatus of claim 12, wherein the image analyzer/processor is configured to orient the second image to the overlay image by adjusting a first distance between the fiduciary markers in the second image with respect to a distance between the fiduciary markers in the overlay image, and by adjusting an angle between the fiduciary markers and the platform in the second image with respect to an angle between the fiduciary markers and the platform in the overlay image to achieve a same orientation between the first image and the second image.

14. The apparatus of claim 12, wherein the first imaging apparatus is a visible light imager, and wherein the second imaging apparatus is an X-ray imager.

15. The apparatus of claim 12, wherein the first imaging apparatus is in a different location from the second imaging apparatus, and wherein the platform is configured to be relocated from the first imaging apparatus to the second imaging apparatus.

16. The apparatus of claim 12, wherein the image analyzer/processor is configured to annotate the locations of biologically occurring features in the tissue sample, wherein the image analyzer/processor is configured to produce an annotation overlay that comprises the annotations, and wherein the annotations represent guidelines for dissection.

17. The apparatus of claim 16 further comprising an annotations projector configured to project the annotations onto the tissue sample to guide dissection.

18. The apparatus of claim 17 further comprising a robotic tissue handling system configured to cut and/or section the tissue sample as guided by the annotations projected onto the tissue sample.
